(19) United States
(12) Patent Application Publication
(10) Pub. No.: US 2008/0181983 A1
(43) Pub. Date: Jul. 31, 2008

(54) Injection Molding Nozzle

(76) Inventors: Zakiul HAQUE, Essex, VT (US); Daniel Hontheim, Bettingen (DE); Udo Schwarzkopf, Trierweller (DE); Abdealam Bouti, Swanton, VT (US)

Correspondence Address: HUSKY INJECTION MOLDING SYSTEMS, LTD;CO/AMC INTELLECTUAL PROPERTY GRP, 500 QUEEN ST. SOUTH, BOLTON, ON, L7E 5S5, omitted

(21) Appl. No.: 11/956,742

(22) Filed: Dec. 14, 2007

Related U.S. Application Data
(60) Provisional application No. 60/887,391, filed on Jan. 31, 2007.

(51) Int. Cl. B29C 45/20

(52) U.S. Cl. 425/571

(57) ABSTRACT

A nozzle comprises a nozzle housing having a preload engagement surface, a nozzle tip, a tip retainer having a preload engagement surface that retains the nozzle tip against the nozzle housing, and a preload limiter gap between the tip retainer and the nozzle housing comprising a spaced distance between the preload engagement surfaces when the nozzle is in a first position and a second position that creates a desired amount of preload force P when the nozzle is in the second position. In another embodiment, a nozzle comprises a nozzle housing, a nozzle tip, and a tip retainer movable with respect to the nozzle tip along the nozzle housing and that retains the nozzle tip against the nozzle housing. A tapered interface disposed between the tip insert and the tip retainer at an angle greater than or less than 90 degrees with respect to a longitudinal axis of the nozzle.

### CROSS REFERENCE TO RELATED PATENT APPLICATION

This patent application is a substitution for patent application of prior U.S. Provisional Patent Application No. 60/887391, filed Jan. 31, 2007. This patent application also claims the benefit and priority date of prior provisional U.S. Patent Application No. 60/887391, filed Jan. 31, 2007.

### TECHNICAL FIELD

The present disclosure relates to molding systems and, more particularly, relates to nozzles for use with injection molding systems.

### BACKGROUND INFORMATION

The state of the art includes various nozzles and nozzle tips for molding systems including, but not limited to, hot-runner injection molding systems. Hot-runner nozzles may typically include either a valve-gate style or a hot-tip style nozzles. In the valve-gate style nozzles, a separate stem moves inside the nozzle and a tip acts as a valve to selectively start and stop the flow of resin through the nozzle. In the hot-tip style nozzles, a small gate area at the end of the tip of the nozzle freezes off to thereby stop the flow of resin through the nozzle. The present disclosure may apply to valve-gate style and/or hot-tip style nozzles.

Referring specifically to FIGS. 1 and 2, two exemplary hot runner nozzle tips 1 are shown. The nozzle tip 1 may comprise a nozzle housing 2 including a melt channel 6 and a tip insert 3 including a tip channel 7 in fluid communication with the melt channel 6 and at least one outlet aperture 8 in fluid communication with the tip channel 7. The tip insert 3 may be secured relative to the nozzle housing 2 of the nozzle 1 (for example, about the proximate end 9 of the nozzle housing 2) by way of a tip retainer 4 removably affixed to the nozzle housing 2. The tip retainer 4 may be removably affixed to the nozzle housing 2 by way of a threaded region 10 which may threadably engage with a corresponding threaded region 11 of the nozzle housing 2.

For example, the tip retainer 4, FIG. 1, may comprise a threaded region 10 having internal threads (i.e., threads disposed about a surface 12 generally facing radially towards the melt channel 6) which may engage with external threads of the threaded region 11 on the nozzle housing 2 (i.e., threads disposed about a surface 13 generally facing radially away from the melt channel 6). According to another embodiment, the tip retainer 4, FIG. 2, may comprise a threaded region 10 having external threads (i.e., threads disposed about a surface 14 generally facing radially away from the melt channel 6) which may engage with internal threads of the threaded region 11 on the nozzle housing 2 (i.e., threads disposed about a surface 15 generally facing radially towards the melt channel 6).

In practice, the nozzle 1, FIGS. 1 and 2, may be assembled by threading the tip retainer 4 onto the nozzle housing 2 using a torque wrench (not shown) until a desired preload force/torque is applied between the tip insert 3 and the nozzle housing 2. The nozzle 1 may include a gap or spacing 16 between the nozzle housing 2 and the tip retainer 4 when the nozzle 1 is fully assembled. The gap 16 may be used to facilitate manufacturing of various components of the nozzle 1 and reduce tolerance stack build-up while still allowing the tip retainer 4 to be threaded far enough onto the nozzle housing 2 to apply the desired force/torque against the tip insert 3. For example, the gap 16 may range from between approximately 0.3 to approximately 0.6 mm.

While the use of the gap 16 allows for the desired amount of preload force P to be created and facilitates manufacturing of the various components of the nozzle 1, the gap 16 does suffer from several limitations. For example, the amount of preload force applied by the tip retainer 4 may be incorrectly set due to operator error, torque wrench error, or the like. If the force applied by the tip retainer 4 is too small, leakage may occur between the nozzle housing 2 and the tip insert 3. Alternatively, if the force applied by the tip retainer 4 is too large, the nozzle 1 may be damaged. The tip insert 3 (and specifically the flange 17 of the tip insert 3) may be particularly susceptible to damage 23 due to the excessive force since it may be constructed from a material having a lower strength compared to either the nozzle housing 2 and/or the tip retainer 4.

Another limitation of gap 16 is that load injection fluctuation forces F_{c} applied against the tip retainer 4 during normal operating of the injection molding machine may be transmitted through the tip retainer 4 and against the tip insert 3 thereby increasing the force exposed to the tip insert flange 17. During operation of the injection molding machine (not shown), resin which is injected into the mold cavity (not shown) at a high pressure exerts a force F_{c} against the distal end 25 of the tip retainer 4 as the mold cavity (not shown) is filled. This force F_{c} generally cyclically fluctuates as the mold cavity is filled (wherein the force F_{c} is highest) until the mold cavity is opened (wherein the force F_{c} is lowest). The force F_{c} may be transmitted through the tip retainer 4 where it ultimately compresses the tip insert flange 17 against the nozzle housing 2 and creates tensile stress at the corner 19 of the flange 17. This cyclic force loading F_{c} of the tip insert flange 17 may cause fatigue to the tip insert flange 17 and may eventually result in failure of the tip insert flange 17 and/or leakage of the seal 21 between the nozzle housing 2 and the tip insert 3.

A further limitation of the nozzle 1 described in FIGS. 1 and 2 is that the surface 27 of the tip insert flange 17 and the surface 28 of the tip retainer 4 may be arranged substantially perpendicular to the longitudinal axis of the nozzle 1. As a result, the force transmitted by the tip retainer 4 against the tip insert flange 17 of the tip insert 3 may be highly concentrated along the surfaces 27, 28 of the tip insert flange 17 and the tip retainer 4. Since the tip retainer 4 and/or the nozzle tip 2 may be constructed from a material having a higher strength compared to the tip insert flange 17, the high stress concentration along the tip insert 17 may exceed the yield strength limit of the material of the tip insert flange 17 resulting in damage to the tip insert flange 17.

Additionally, the perpendicular arrangement of the surfaces 27, 28 of the tip insert flange 17 and the tip retainer 4 may result in uneven distribution of force along the seal 21 between the tip insert 3 and the nozzle housing 2. In particular, more force may be applied to the outside region of the seal 21 compared to the inside region of the seal 21 due to the perpendicular geometry of the surfaces 27, 28 of the tip insert flange 17 and the tip retainer 4.

Accordingly, what is needed is an improved nozzle that may allow a desired amount of preload force/torque to be applied to the tip insert and which substantially prevents, reduces, and/or limits additional, excessive force from being transmitted against the tip insert. Additionally, what is needed is a nozzle that may reduce the stress concentration between the tip insert and the tip retainer and which may improve the seal between the nozzle housing and the tip insert.

It is important to note that the present disclosure is not intended to be limited to a system or method which must satisfy one or more of any stated objects or features of the invention. It is also important to note that the present disclosure is not limited to the preferred, exemplary, or primary embodiment(s) described herein. Modifications and substitutions by one of ordinary skill in the art are considered to be within the scope of the present disclosure.

### BRIEF DESCRIPTION OF THE DRAWINGS

These and other features and advantages of the present disclosure will be better understood by reading the following detailed description, taken together with the drawings wherein:

FIGS. 1 and 2 are cross-sectional views of prior art nozzles;

FIG. 3 is a cross-sectional view of one embodiment of a nozzle having a preload limiter gap according to the present disclosure shown in a first, partially assembled position;

FIG. 4 is a cross-sectional view of another embodiment of a nozzle having a preload limiter gap according to the present disclosure shown in a first, partially assembled position;

FIG. 5 is a cross-sectional view of the nozzle shown in FIG. 3 in a second, fully assembled position;

FIG. 6 is a cross-sectional view of the nozzle shown in FIG. 4 in a second, fully assembled position;

FIG. 7a is a partial, cross-sectional view of another embodiment of a nozzle according to the present disclosure having a linear or constant frustoconical shaped interface;

FIG. 7b is a partial, cross-sectional view of the nozzle shown in FIG. 7a having a non-linear, arcuate, or radiused shaped interface according to the present disclosure;

FIG. 8a is a partial, cross-sectional view of another embodiment of a nozzle according to the present disclosure having a linear or constant frustoconical shaped interface;

FIG. 8b is a partial, cross-sectional view of the nozzle shown in FIG. 8a having a non-linear, arcuate, or radiused shaped interface according to the present disclosure

FIG. 9a is a cross-sectional view of another embodiment of a nozzle according to the present disclosure comprising a tapered interface having both a non-linear, arcuate, or radiused shaped interface and a linear or constant frustoconical shaped interface; and

FIG. 9b is a close-up of the tapered interface having both a non-linear, arcuate, or radiused shaped interface and a linear or constant frustoconical shaped interface as shown in FIG. 9a.

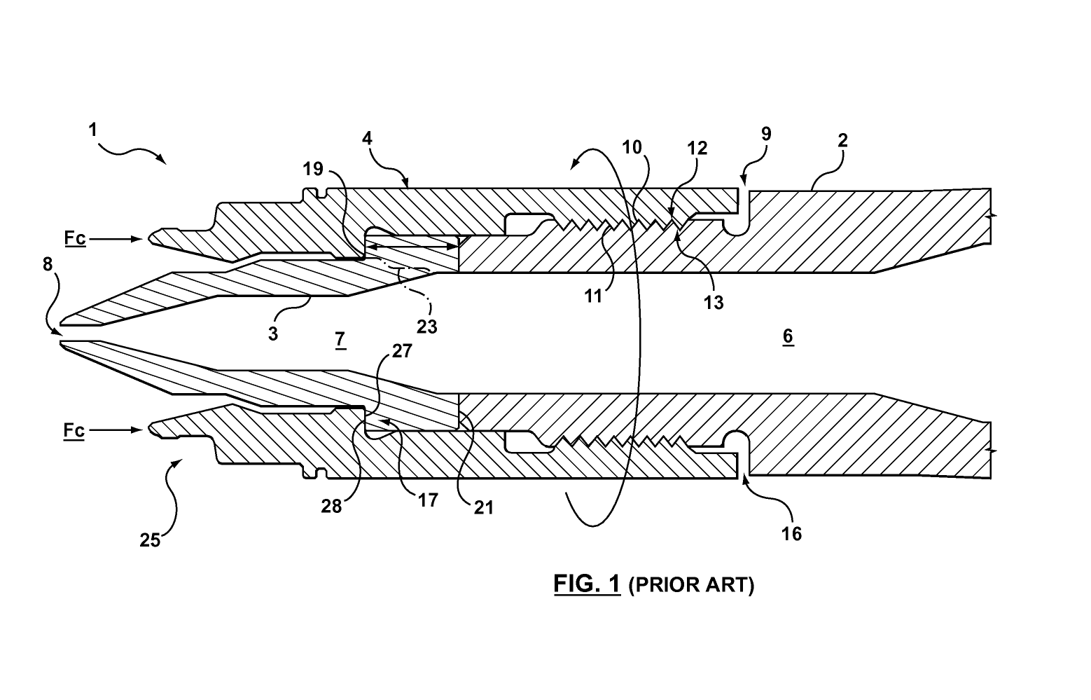

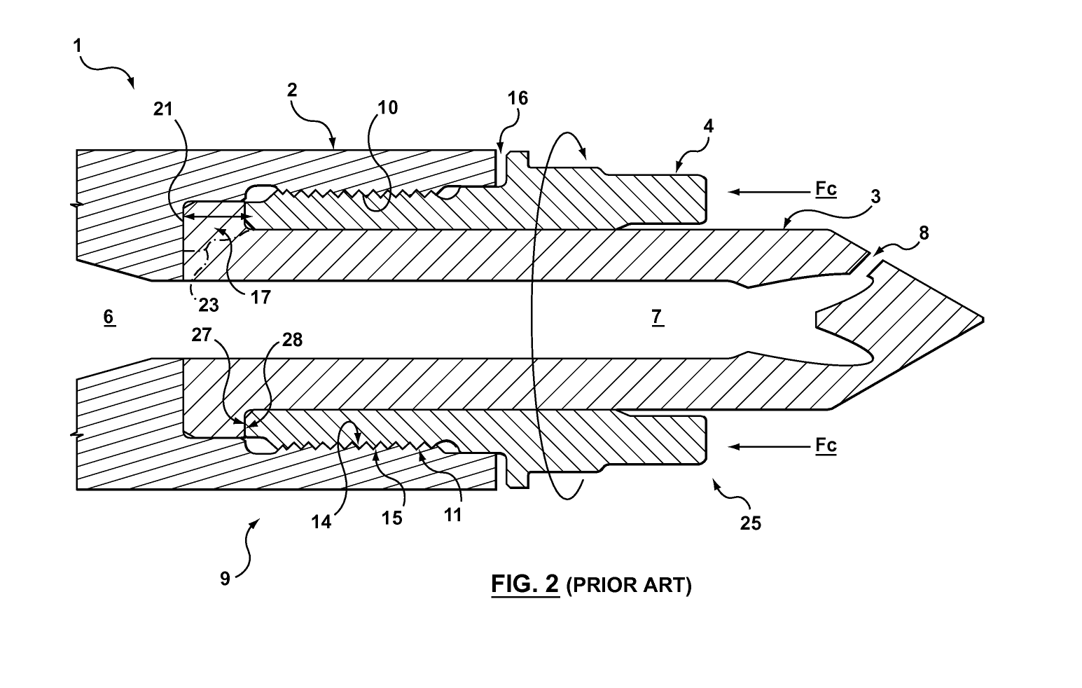

### DETAILED DESCRIPTION OF THE PREFERRED EMBODIMENTS

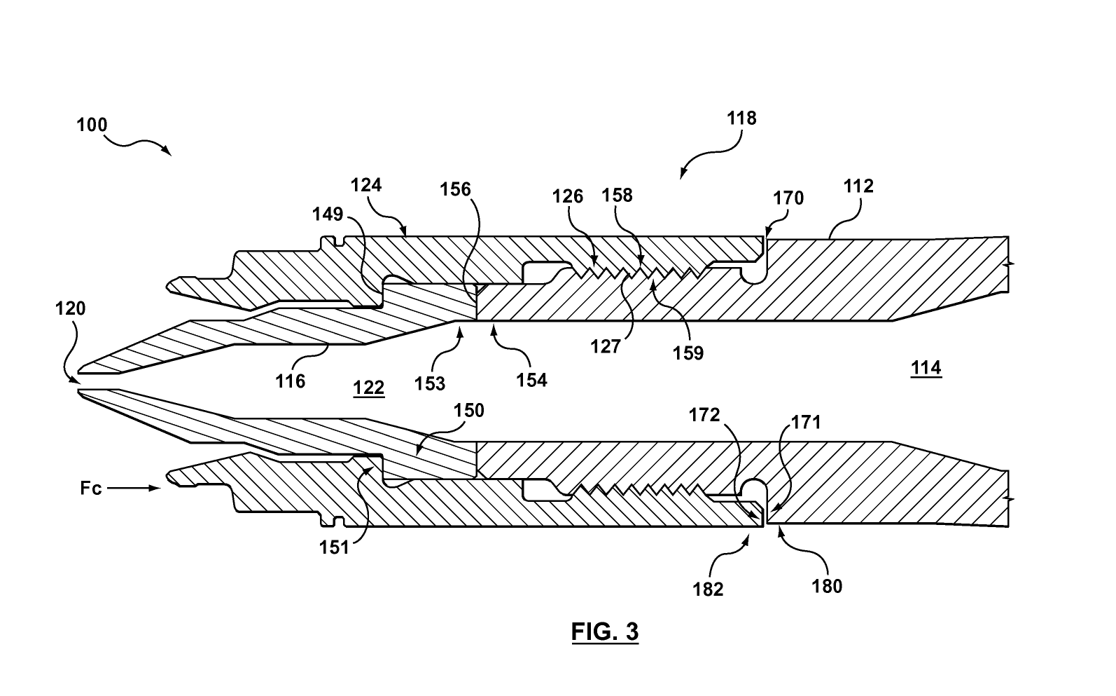

According to one embodiment, the present disclosure may feature an injection molding nozzle 100, FIGS. 3-6, which may comprise a nozzle housing 112, a tip insert 116 that may be secured relative to the nozzle housing 112 by a tip retainer 124, and a preload limiter gap 170 between the nozzle housing 112 and the tip retainer 124. As will be explained in greater detail hereinbelow, the preload limiter gap 170 may allow for a desired amount of preload force/torque P to be applied to the tip insert 116 and/or substantially prevent, reduce, and/or limit additional, excessive force from being transmitted against the tip insert 116.

The nozzle 100 may comprise an elongated nozzle housing 112 configured to be secured to a source of pressurized molten material (not shown) and a melt channel 114 therethrough that may be in fluid communication with the source of pressurized molten material in any manner known to those skilled in the art. A tip insert 116 may be installed about the proximal end 118 of the nozzle housing 112 so that a tip channel 122 formed in tip insert 116 may be in fluid communication with the melt channel 114. The tip channel 122 may also include at least one outlet aperture 120 in fluid communication with tip channel 122.

The nozzle 100 may also comprise a tip retainer 124 configured to receive and retain the tip insert 116 relative to the nozzle housing 112 when tip retainer 124 is secured to the proximal end 118 of nozzle housing 112. The tip retainer 124 may be removably affixed to the proximal end 118 of the nozzle housing 112 by way of threads 126 that threadably engage with corresponding threads 127 on the nozzle housing 112 or any functional equivalents thereof. As the tip retainer 124 is screwed onto the proximate end 118 of the nozzle housing 112, a flange engagement portion 151 of the tip retainer 124 may generally apply a force/torque against at least a portion of a tip insert flange 150 extending radially from the tip insert 116. The force applied against the tip insert 116 (and specifically the tip insert flange 150) urges the insert seal portion 153 of the tip insert 116 against the nozzle seal portion 154 of the nozzle housing 112 to form a seal 156 between the tip insert 116 and the nozzle housing 112.

While not a limitation of the present disclosure unless specifically claimed as such, the tip insert 116 may be constructed from a material having a high thermal conductivity (such as, but not limited to, a copper alloy or the like). In contrast, the nozzle housing 112 and/or the tip retainer 124 may be constructed from a material having a lower thermal conductivity but a higher strength compared to the tip insert 116. As such, the tip insert 116 (and specifically the tip insert flange 150) is particularly susceptible to damage due to excessive force (particularly excessive compressive force).

As mentioned above, the nozzle 100 according to the present disclosure may also feature a preload limiter gap 170 between the nozzle housing 112 and the tip retainer 124. As will be explained in greater detail hereinbelow, by setting the dimensions and tolerances of the assembled nozzle housing 112, tip insert 116, and the tip retainer 124, the preload limiter gap 170 may allow for a predefined amount of preload force/torque P to be applied to the tip insert 116 (and specifically the tip insert flange 150) to create the seal 156 and/or substantially prevent, reduce, and/or limit additional, excessive force from being transmitted against the tip insert 116.

As used herein, the term “preload force/torque P” is intended to mean a desired amount of force/torque between the tip insert 116, tip retainer 124 and the nozzle housing 112 that will create a satisfactory and reliable seal 156 between the tip insert 116 and the nozzle housing 112 without causing damage to the nozzle 100. The term “excessive force” as used herein is intended to mean a force between the tip insert 116 and the nozzle housing 112 in excess of a predefined limit/threshold above the preload force/torque P. The preload force/torque P and force threshold are considered within the knowledge of one of ordinary skill in the art and may be determined experimentally or through finite element analysis and will vary depending upon the intended application. For exemplary purposes only, the preload torque may be between approximately 30 ft-lb to approximately 35 ft-lb and the predefined limit/threshold may be between approximately 0.03 mm to approximately 0.035 mm.

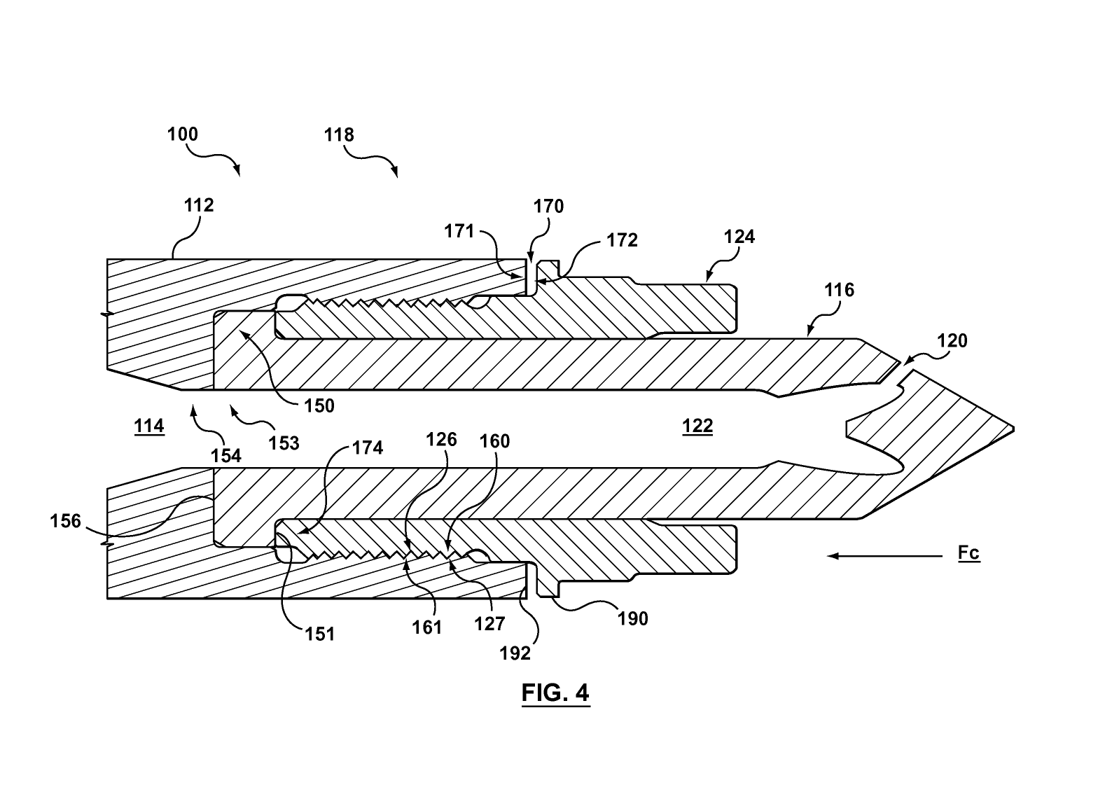

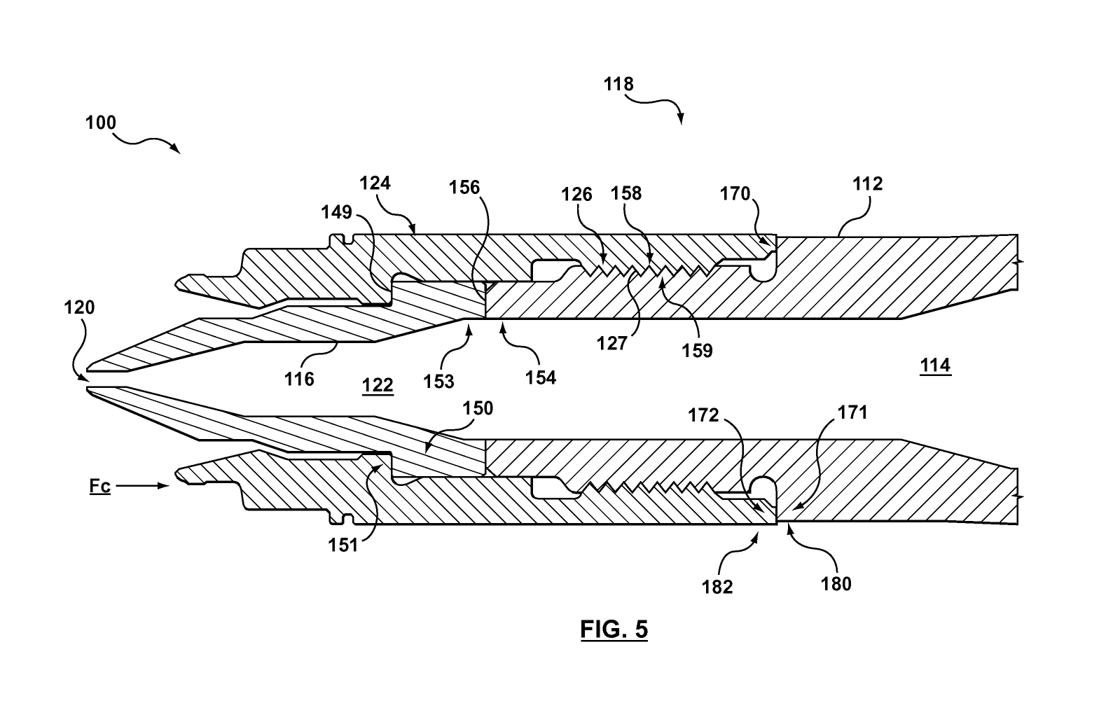

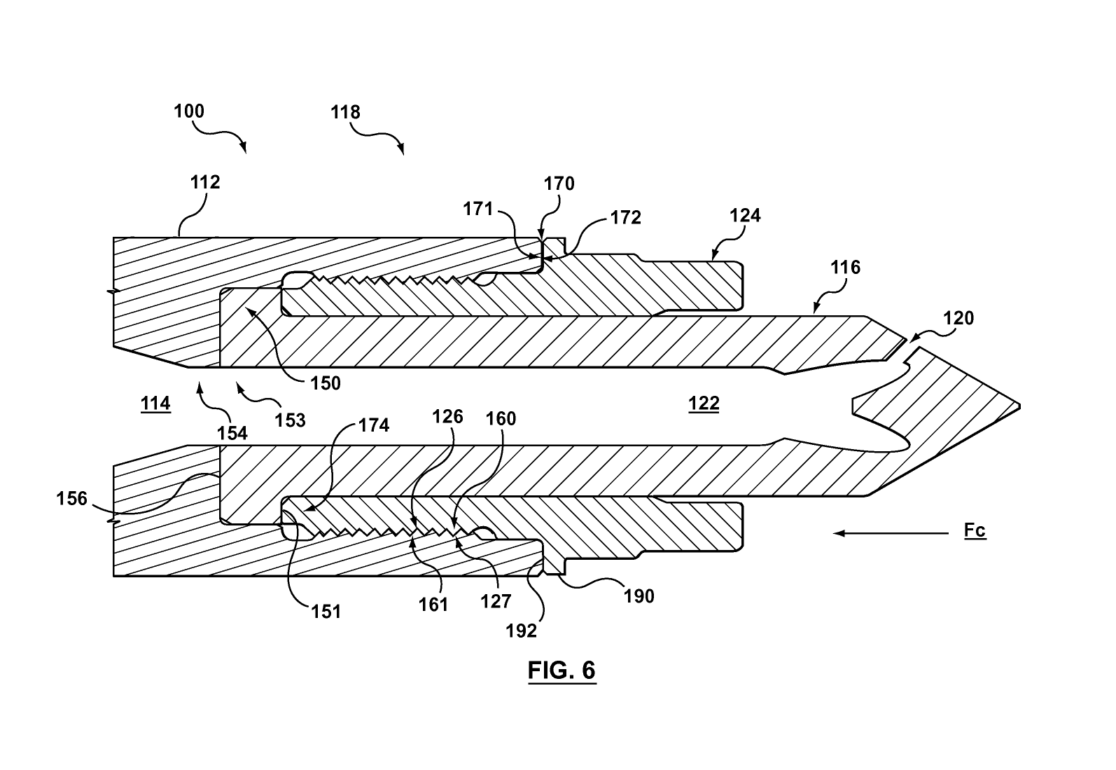

The preload limiter gap 170 may be defined as the distance between the preload engagement surface 171, 172 of the nozzle housing 112 and the tip retainer 124 in a first, partially assembled position (wherein the tip insert flange 150 is initially substantially contacting/abutting both the flange engagement portion 151 of the tip retainer 124 and the nozzle seal engagement portion 154 of the nozzle housing 112 as shown in FIGS. 3 and 4) and a second, fully-assembled position (wherein the preload engagement surfaces 171, 172 of the nozzle housing and the tip retainer 124 substantially abut against each other as shown in FIGS. 5 and 6) that will create the desired amount of preload force P. While not a limitation of the present disclosure unless specifically claimed as such, the preload limiter gap 170 may be between approximately 0.03 to approximately 0.08 mm. Such a preload limiter gap 170 may result in a preload torque P of approximately 30 ft-lb depending on the materials chosen.

According to one embodiment of the nozzle 100 shown in FIGS. 3 and 5, the tip retainer 124 may comprise internal threads 126 (i.e., threads 126 disposed about a surface 158 of the tip retainer 124 generally facing radially towards the melt channel 114) which may engage with external threads 127 on the nozzle housing 112 (i.e., threads 127 disposed about a surface 159 of the nozzle housing 112 generally facing radially away from the melt channel 114). The flange engagement portion 151 of the tip retainer 124 may comprise an annular lip 149 extending generally radially inwardly towards the channels 122, 114 which may be sized and shaped to substantially abut against or engage at least a portion of the tip insert flange 150 as the tip retainer 124 is threaded onto the nozzle housing 112. Additionally, the preload engagement surface 171 of the nozzle housing 112 may comprise a generally annular stop flange 180 extending generally radially outwardly while the preload engagement surface 172 of the tip retainer 124 may comprise a distal end portion 182 of the tip retainer 124.

Referring specifically to FIG. 3, the nozzle 100 is shown in the first, partially assembled position wherein the tip retainer 124 has been threaded onto the nozzle housing 112 until the tip insert flange 150 initially substantially contacts/abuts both the annular lip 149 of the tip retainer 124 and the nozzle seal portion 154 of the nozzle housing 112. As can be seen, there is a gap or space between the annular stop flange 180 of the nozzle housing 112 and the distal end portion 182 of the tip retainer 124.

Referring now to FIG. 5, the nozzle 100 is shown in the second, fully-assembled position. In particular, the tip retainer 124 has been threaded onto the nozzle housing 112 until the distal end portion 182 of the tip retainer 124 substantially abuts against/contacts the annular stop flange 180 of the nozzle housing 112. As can be seen, the gap or space between the annular stop flange 180 of the nozzle housing 112 and the distal end portion 182 of the tip retainer 124 has been closed. When in the second position, the tip retainer 124 transfers a preload force/torque P against the tip insert 116 (and in particular, the tip insert flange 150) which creates the seal 156 between the tip insert 116 and the nozzle housing 112.

The preload limiter gap 170 may therefore defined as the distance between the annular stop flange 180 and the distal end portion 182 in the first, partially assembled position (as shown in FIG. 3) and the second, fully assembled position (as shown in FIG. 5) which will result in the tip retainer 124 transferring a force against the tip insert that is approximately equal to the desired amount of preload force/torque.

As can be seen, once the nozzle 100 is in the second position as shown in FIG. 5, the annular stop flange 180 substantially prevents the tip retainer 124 from being threaded onto the nozzle housing 112 any further. Because the nozzle housing 112 and the tip retainer 124 may be constructed from a generally strong material (such, but not limited to, steel or the like), the nozzle housing 112 and the tip retainer 124 have a relatively low amount of deformability compared to the tip insert 116 (which may be constructed from a relatively weaker, more deformable material such as, but not limited to, copper alloys and the like). As a result, any excessive force due to accidental over-tightening of the tip retainer 124 (e.g., resulting from operator error, torque wrench error, or the like) as well as the injection back load injection force F_{c} transmitted through the tip retainer 124 or the like may be transmitted through the tip retainer 124 to the nozzle housing 112 instead of the tip insert flange 150.

According to another embodiment of the nozzle 100 shown in shown in FIGS. 4 and 6, the tip retainer 124 may comprise external threads 126 (i.e., threads 126 disposed about a surface 160 of the tip retainer 124 generally facing radially away from the melt channel 114) which may engage with internal threads 127 on the nozzle housing 112 (i.e., threads 127 disposed about a surface 161 of the nozzle housing 112 generally facing radially towards the melt channel 114). The flange engagement portion 151 of the tip retainer 124 may comprise a distal end portion 174 which may substantially abut against or engage at least a portion of the tip insert flange 150 as the tip retainer 124 is threaded onto the nozzle housing 112. Additionally, the preload engagement surface 172 of the tip retainer 124 may comprise a generally annular stop flange 190 extending generally radially outwardly while the preload engagement surface 171 of the nozzle housing 112 may comprise a proximate end portion 192 of the nozzle housing 112.

Referring specifically to FIG. 4, the nozzle 100 is shown in the first, partially assembled position wherein the tip retainer 124 has been threaded onto the nozzle housing 112 until the tip insert flange 150 initially substantially contacts/abuts both the distal end portion 174 of the tip retainer 124 and the nozzle seal portion 154 of the nozzle housing 112. As can be seen, there is a gap or space between the annular stop flange 190 of the tip retainer 124 and the proximate end portion 192 of the nozzle housing 112.

Referring now to FIG. 6, the nozzle 100 is shown in the second, fully assembled position. In particular, the tip retainer 124 has been threaded onto the nozzle housing 112 until the annular stop flange 190 of the tip retainer 124 substantially abuts against/contacts the proximate end portion 192 of the nozzle housing 112. When in this position, the tip retainer 124 may transfer a preload force/torque against the tip insert 116 (and in particular, the tip insert flange 150) which creates the seal 156 between the tip insert 116 and the nozzle housing 112.

The preload limiter gap 170 may therefore be defined as the distance between the annular stop flange 190 and the proximate end portion 192 in the first, partially assembled position (as shown in FIG. 4) and the second, fully assembled position (as shown in FIG. 6) which will result in the tip retainer 124 transferring a force against the tip insert that is approximately equal to the desired amount of preload force.

As can be seen, once the nozzle 100 is in the second, fully assembled position as shown in FIG. 6, the annular stop flange 190 substantially prevents the tip retainer 124 from being threaded onto the nozzle housing 112 any further. Because the nozzle housing 112 and the tip retainer 124 may be constructed from a generally strong material (such, but not limited to, steel or the like), the nozzle housing 112 and the tip retainer 124 have a relatively low amount of deformability compared to the tip insert 116 (which may be constructed from a relatively weaker, more deformable material such as, but not limited to, copper alloys and the like). As a result, any excessive force due to accidental over-tightening of the tip retainer 124 (e.g., resulting from operator error, torque wrench error, or the like) as well as the injection back load injection force F_{c} transmitted through the tip retainer 124 or the like may be transmitted through the tip retainer 124 to the nozzle housing 112 instead of the tip insert flange 150.

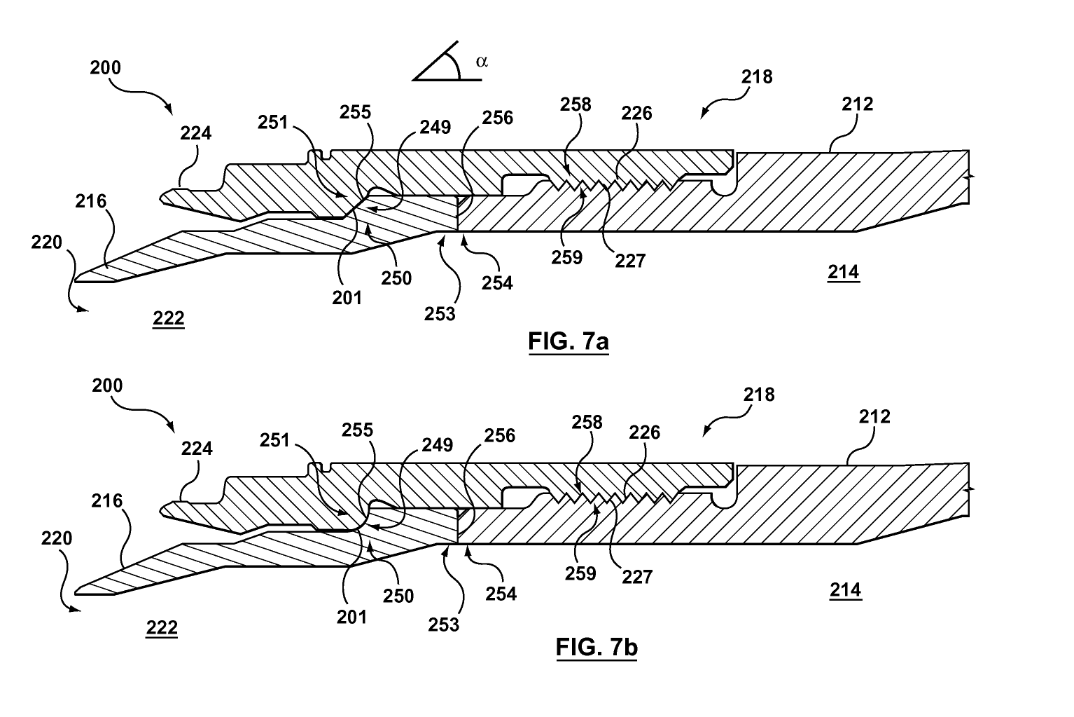

According to yet another embodiment, the present disclosure may feature a nozzle 200, FIGS. 7-9 (only half of which is shown for clarity), comprising a nozzle housing 212, a tip insert 216, a tip retainer 224, and a tapered flange interface 201 between the tip insert 216 and the tip retainer 224. As will be described in greater detail hereinbelow, the tapered flange interface 201 may reduce the stress concentration between the tip insert 216 and the tip retainer 224 and may improve the seal 256 between the nozzle housing 212 and the tip insert 216. While not a limitation of the present disclosure unless specifically claimed as such, those skilled in the art will recognize that the tapered flange interface 201 may be combined with any embodiment of the preload limiter gap 170 described above in FIGS. 3-6.

The nozzle 200 may comprise an elongated nozzle housing 212 configured to be secured to a source of pressurized molten material (not shown) and may include a melt channel 214 therethrough that may be in fluid communication with the source of pressurized molten material in any manner known to those skilled in the art. The tip insert 216 may be installed about the proximal end 218 of the nozzle housing 212 so that a tip channel 222 formed in tip insert 216 may be in fluid communication with the melt channel 214. The tip channel 212 may also include at least one outlet aperture 220 in fluid communication with tip channel 222.

The nozzle 200 may further comprise a tip retainer 224 configured to receive and retain the tip insert 216 relative to the nozzle body 212 when tip retainer 224 is disposed about a proximal end 218 of nozzle housing 212. The tip retainer 224 may be removably affixed to the proximal end 218 of the nozzle housing 212 by way of threads 226 that threadably engage with corresponding threads 227 on the nozzle housing 212 or any functional equivalents thereof. As the tip retainer 224 is screwed onto the proximate end 218 of the nozzle housing 212, a flange engagement portion 251 of the tip retainer 224 may apply a force/torque against at least a portion of the engagement surface 249 of a tip insert flange 250 extending radially from the tip insert 216. The force applied against the tip insert 216 (and specifically the tip insert flange 250) urges the insert seal portion 253 of the tip insert 216 against the nozzle seal portion 254 of the nozzle housing 212 to form a seal 256 between the tip insert 216 and the nozzle housing 212.

For example, the nozzle 200, FIG. 7, may comprise a tip retainer 224 having internal threads 226 (i.e., threads 226 disposed about a surface 258 of the tip retainer 224 generally facing radially towards the melt channel 214) which may engage with external threads 227 on the nozzle housing 212 (i.e., threads 227 disposed about a surface 259 of the nozzle housing 212 generally facing radially away from the melt channel 214). The flange engagement portion 251 of the tip retainer 224 may comprise an annular lip 255 extending generally radially inwardly from the tip retainer 224 towards the channels 214, 222 which may be sized and shaped to substantially abut against or engage at least a portion of the engagement surface 249 tip insert flange 250 as the tip retainer 224 is threaded onto the nozzle housing 212.

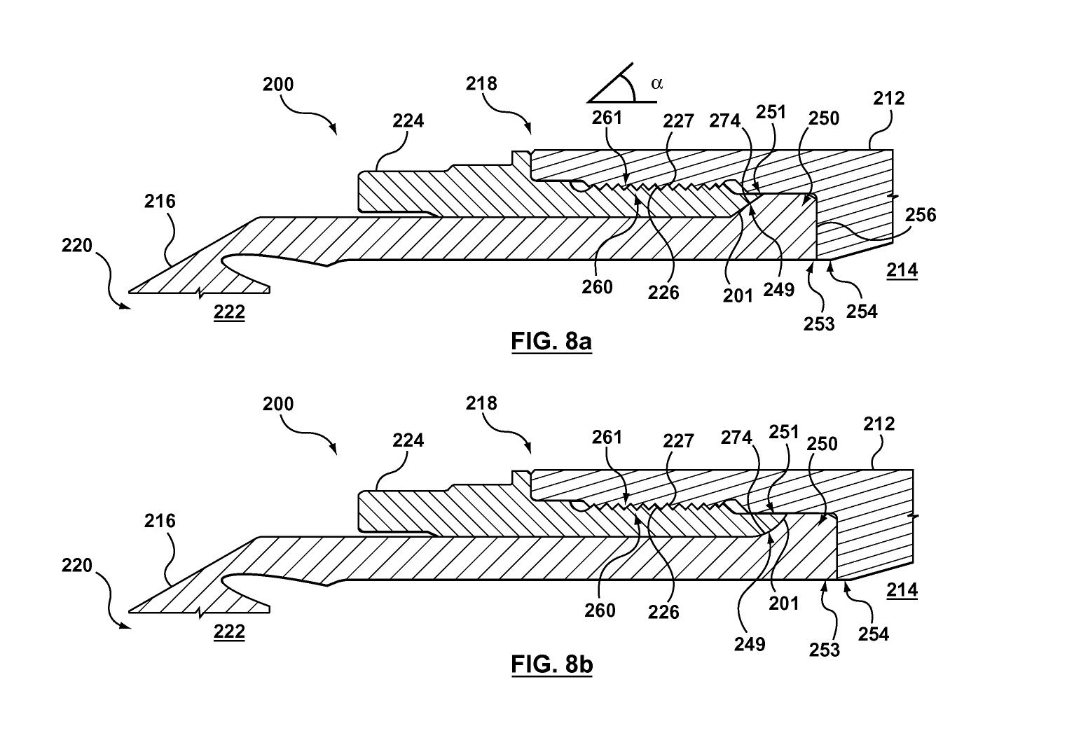

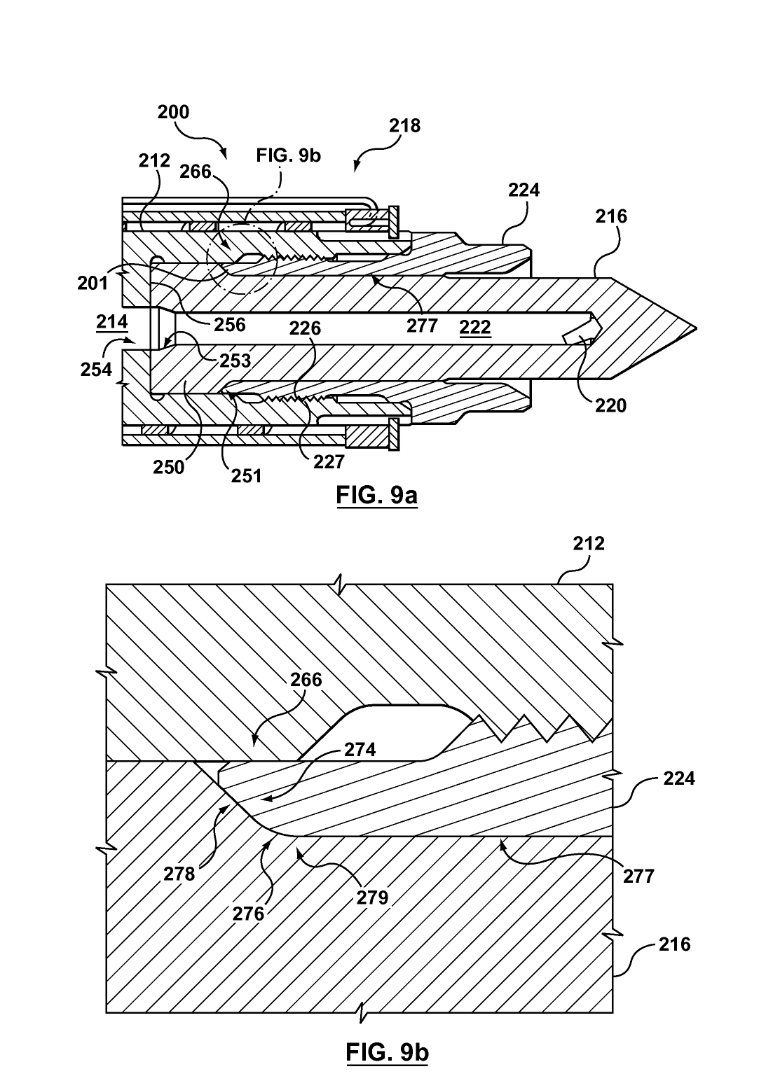

According to another embodiment, the nozzle 200, FIGS. 8 and 9, may comprise a tip retainer 224 having external threads 226 (i.e., threads 226 disposed about a surface 260 of the tip retainer 224 generally facing radially away from the melt channel 214) which may engage with internal threads 227 on the nozzle housing 212 (i.e., threads 227 disposed about a surface 261 of the nozzle housing 212 generally facing radially towards the melt channel 214). The flange engagement portion 251 of the tip retainer 224 may comprise a distal end portion 274 that may substantially abut against or engage at least a portion of the engagement surface 249 of the tip insert flange 250 as the tip retainer 224 is threaded onto the nozzle housing 212.

According to one embodiment, the nozzle housing 212 may have a portion 266 (best seen in FIG. 9b) which has an inner diameter sized and shaped to substantially abut against the distal end portion 274 of the flange engagement portion 251 of the tip retainer 224. A spacing (not shown) may be provided between the portion 266 of the nozzle housing 212 and the distal end portion 274 of the tip retainer 224 to allow for thermal expansion or the like. As may be appreciated, the portion 266 of the nozzle housing 212 may support the distal end portion 274 of the tip retainer 224, thereby substantially preventing the distal end portion 274 of the tip retainer 224 from bending radially outwardly when under torque.

In either of the embodiments described in FIGS. 7-9, the tip retainer 224 may apply a force against the tip insert 216 to create the seal 256 between the nozzle housing 212 and the tip insert 216. The force applied by the tip retainer 224 should be sufficient enough to substantially prevent leakage of resin from the melt channels 214, 222. The tip retainer 224 may also transfer additional forces against the tip insert flange 250 due to over-tightening of the of the tip retainer 224 and/or injection back load force F_{c} applied to the tip retainer 224 under normal operating conditions of the injection molding machine. Regardless of the origin or source of the force applied against the tip insert 216, the tip insert 216 (and in particular, the tip insert flange 250) may be damaged if the force stress concentration between the tip retainer 224 and the tip insert flange 250 exceeds the yield strength limit of the material of the tip insert flange 250.

Referring back to FIGS. 7-9, the nozzle 200 according to the present disclosure may comprise a tapered flange interface 201 between the flange engagement portion 251 and the surface 249 of the tip insert flange 250. As will be discussed in greater detail hereinbelow, the tapered flange interface 201 between the tip insert 216 and the tip retainer 224 may reduce the force concentration applied to the tip insert 216, thereby reducing the likelihood of damaging the tip insert 216. The tapered flange interface 201 may reduce the contact pressure (yielding) and increase the fatigue endurance limit of the tip insert 216. The tapered flange interface 201 may also improve the seal 256 between the nozzle housing 212 and the tip insert 216 by distributing the force applied to the tip insert 216 more evenly across the seal 256.

As shown in FIGS. 7a and 8a, the tapered flange interface 201 may comprise a substantially linear or constant frustoconical shape. As used herein, a linear or constant frustoconical shaped interface 201 is intended to mean that the flange engagement portion 251 and the surface 249 of the tip insert flange 250 have generally constant sloped outer surfaces that are not perpendicular to each other. The slope or angle α of the substantially linear or constant frustoconical shaped interface 201 will depend upon intended application of the nozzle 200 and may be determined experimentally or through finite element analysis. While not a limitation of the present disclosure unless specifically claimed as such, the angle α of the substantially linear or constant frustoconical shaped interface 201 may range between approximately 25 to approximately 35 degrees from the longitudinal axis of the nozzle 200.

According to another embodiment, the tapered flange interface 201, FIGS. 7b and 8b, may comprise a substantially non-linear, arcuate, or radiused frustoconical shape. As used herein, a non-linear, arcuate, or radiused shaped frustoconical interface 201 is intended to mean that the flange engagement portion 251 and the surface 249 of the tip insert flange 250 have an arc or curved outer surface that changes along the length of the frustoconical interface 201. The non-linear, arcuate, or radiused frustoconical interface 201 may include convex and/or concaved surfaces. The exact shape of the non-linear, arcuate, or radiused frustoconical interface 201 will depend upon intended application of the nozzle 200 and may be determined experimentally or through finite element analysis. While not a limitation of the present disclosure unless specifically claimed as such, the non-linear, arcuate, or radiused frustoconical interface 201 may include a generally radiused shape having a radius between approximately 0.8 mm to approximately 1.8 mm.

According to yet another embodiment, the tapered flange interface 201, FIG. 9, may comprise a first region 276 having a substantially non-linear, arcuate, or radiused frustoconical shape and a second region 278 having a substantially linear or constant frustoconical shape. Referring specifically to FIG. 9b, the first region 276 of the tapered flange interface 201 may be disposed proximate a transition region 279 between the elongated portion 277 of the tip insert 216 and tip retainer 224 and the tapered interface 201 and may transition into the second region 277. The non-linear, arcuate, or radiused frustoconical interface region 276 may increase the surface area proximate the transition region 279 and therefore reduce the stress concentration proximate the transition region 279. Reducing the stress concentration proximate the transition region 279 may be particularly beneficial since the transition region 279 may exposed to the highest stress concentration and therefore may be most likely to suffer from damage. The use of the substantially linear or constant frustoconical second interface region 278 may further increase the surface area while also facilitating the manufacturing of the tip insert 216 and the tip retainer 224. While the first and second region 276, 278 are shown with a nozzle 200 having an externally threaded tip retainer 224, the first and second region 276, 278 may also be combined with a nozzle 200 having an internally threaded tip insert 224 as shown in FIG. 7.

As mentioned above, the tapered flange interface 201, FIGS. 7-9, may increase the surface contact area between the flange engagement portion 251 of the tip retainer 224 and the engagement surface 249 of the tip insert flange 250 in comparison to nozzle designs wherein the tip insert flange and the tip retainer abut along a generally perpendicularly interface or shoulder. As a result, the stress concentration and pressure along the interface 201 (and, in particular, the tip insert flange 250) may be decreased and the lifespan of the tip insert flange 250 may therefore be increased. It should be noted that the non-linear, arcuate, or radiused shaped interface 201 as shown in FIGS. 7b, 8b, and 9 may provide an additional benefit over the linear or constant interface 201 shown in FIGS. 7a and 8a since the surface area between the flange engagement portion 251 of the tip retainer 224 and the engagement surface 249 of the tip insert flange 250 is further increased.

Additionally, the tapered flange interface 201 according to the present disclosure may provide an improved seal 256 between the nozzle housing 212 and the tip insert 216. In particular, the tapered flange interface 201 may distribute the force transmitted by the tip retainer 224 both along the longitudinal axis of the nozzle 200 as well as along the radial axis of the nozzle 200. Consequently, the tapered flange interface 201 may transfer more force towards the portion of seal 256 closest to the channels 214, 222. Moreover, this longitudinal and radial distribution of force further reduces the stress concentration experienced between the tip insert flange 250 and the nozzle housing 212.

As mentioned above, the present disclosure is not intended to be limited to a system or method which must satisfy one or more of any stated or implied object or feature of the invention and should not be limited to the preferred, exemplary, or primary embodiment(s) described herein. The foregoing description of a preferred embodiment of the invention has been presented for purposes of illustration and description. It is not intended to be exhaustive or to limit the invention to the precise form disclosed. Obvious modifications or variations are possible in light of the above teachings. The embodiment was chosen and described to provide the best illustration of the principles of the invention and its practical application to thereby enable one of ordinary skill in the art to utilize the invention in various embodiments and with various modifications as is suited to the particular use contemplated. All such modifications and variations are within the scope of the invention.

The present disclosure may feature:

1. A nozzle for an injection molding machine comprising:
a nozzle housing defining a melt channel, said nozzle housing comprising a first preload engagement surface;
a nozzle tip having a tip channel and at least one outlet aperture in communication with said tip channel;
a tip retainer that retains said nozzle tip against said nozzle housing such that said tip channel communicates with said melt channel, said tip retainer comprising a second preload engagement surface; and
a preload limiter gap disposed between said tip retainer and said nozzle housing, said preload limiter gap comprising a spaced distance between said first and said second preload engagement surfaces when said nozzle is in a first, partially assembled position and a second, fully-assembled position that creates a desired amount of preload force P when said nozzle is in said second, fully-assembled position.

2. The nozzle of feature 1 wherein said nozzle tip further comprises a tip insert flange, wherein said tip insert flange initially substantially abuts both a flange engagement portion of said tip retainer and a nozzle seal engagement portion of said nozzle housing when said nozzle is in said first, partially assembled position.

3. The nozzle of feature 2 wherein said first and said second preload engagement surfaces substantially abut against each other when said nozzle is in said second, fully assembled position.

4. The nozzle of feature 3 wherein said preload limiter gap is between approximately 0.03 to approximately 0.08 mm.

5. The nozzle of feature 4 wherein said preload torque P is between approximately 30 to approximately 35 ft-lb.

6. The nozzle of feature 3 wherein said tip retainer comprises an internally threaded region configured to threadably engage with an external threaded disposed on said nozzle housing.

7. The nozzle of feature 6 wherein said flange engagement portion comprises an annular lip extending generally radially inwardly towards said melt and said tip channels, said annular lip configured to substantially abut against at least a portion of said tip insert flange as said tip retainer is threaded onto said nozzle housing.

8. The nozzle of feature 7 wherein said first preload engagement surface comprises a generally annular stop flange extending generally radially outwardly and said second preload engagement surface 172 comprises a distal end portion of said tip retainer.

9. The nozzle of feature 3 wherein said tip retainer comprises an externally threaded region configured to threadably engage with an internally threaded disposed on said nozzle housing.

10. The nozzle of feature 9 wherein said flange engagement portion comprises a distal end portion configured to substantially abut against at least a portion of said tip insert flange as said tip retainer is threaded onto said nozzle housing.

11. The nozzle of feature 10 wherein said first preload engagement surface comprises a proximate end portion of said nozzle housing and said second preload engagement surface comprises a generally annular stop flange extending generally radially outwardly.

12. A nozzle for an injection molding machine comprising:
a nozzle housing defining a melt channel;
a nozzle tip having a tip channel and at least one outlet aperture in communication with said tip channel;
a tip retainer comprising a threaded region for threadably engaging with said nozzle housing and to retain said nozzle tip against said nozzle housing such that said tip channel communicates with said melt channel, wherein said tip retainer movably with respect to said nozzle tip along said nozzle housing; and
a tapered interface between said tip insert and said tip retainer, wherein said tapered interface is substantially disposed at an angle greater than or less than 90 degrees with respect to a longitudinal axis of said nozzle.

13. The nozzle of feature 12 wherein said tapered interface comprises a substantially linear frustoconical shape.

14. The nozzle of feature 13 wherein said substantially linear frustoconical shaped interface be disposed at an angle between approximately 25 to approximately 35 degrees from a longitudinal axis of said nozzle.

15. The nozzle of feature 12 wherein said tapered interface comprises a non-linear shaped frustoconical shape.

16. The nozzle of feature 13 wherein said non-linear frustoconical shaped interface comprises a radiused frustoconical shaped interface having a radius between approximately 0.8 mm to approximately 1.8 mm.

17. The nozzle of feature 13 wherein said non-linear frustoconical shaped interface comprises a generally convex shaped frustoconical interface.

18. The nozzle of feature 13 wherein said non-linear frustoconical shaped interface comprises a generally concave shaped frustoconical interface.

19. The nozzle of feature 12 wherein said tip retainer comprises an internally threaded region configured to threadably engage with an external threaded disposed on said nozzle housing.

20. The nozzle of feature 19 wherein tip retainer comprises an annular lip extending generally radially inwardly towards said melt and said tip channels, said annular lip configured to substantially abut against at least a portion of a tip insert flange of said tip insert as said tip retainer is threaded onto said nozzle housing to form said tapered interface.

21. The nozzle of feature 20 wherein said tapered interface comprises a substantially linear frustoconical shape.

22. The nozzle of feature 21 wherein said substantially linear frustoconical shaped interface be disposed at an angle between approximately 25 to approximately 35 degrees from a longitudinal axis of said nozzle.

23. The nozzle of feature 20 wherein said tapered interface comprises a non-linear shaped frustoconical shape.

24. The nozzle of feature 23 wherein said non-linear frustoconical shaped interface comprises a radiused frustoconical shaped interface having a radius between approximately 0.8 mm to approximately 1.8 mm.

25. The nozzle of feature 23 wherein said non-linear frustoconical shaped interface comprises a generally convex shaped frustoconical interface.

26. The nozzle of feature 23 wherein said non-linear frustoconical shaped interface comprises a generally concave shaped frustoconical interface.

27. The nozzle of feature 12 wherein said tip retainer comprises an externally threaded region configured to threadably engage with an internally threaded disposed on said nozzle housing.

28. The nozzle of feature 27 wherein said tip retainer comprises a distal end portion configured to substantially abut against at least a portion of a tip insert flange of said tip insert as said tip retainer is threaded onto said nozzle housing to form said tapered interface.

29. The nozzle of feature 28 wherein said tapered interface comprises a substantially linear frustoconical shape.

30. The nozzle of feature 29 wherein said substantially linear frustoconical shaped interface be disposed at an angle between approximately 25 to approximately 35 degrees from a longitudinal axis of said nozzle.

31. The nozzle of feature 28 wherein said tapered interface comprises a non-linear shaped frustoconical shape.

32. The nozzle of feature 31 wherein said non-linear frustoconical shaped interface comprises a radiused frustoconical shaped interface having a radius between approximately 0.8 mm to approximately 1.8 mm.

33. The nozzle of feature 31 wherein said non-linear frustoconical shaped interface comprises a generally convex shaped frustoconical interface.

34. The nozzle of feature 31 wherein said non-linear frustoconical shaped interface comprises a generally concave shaped frustoconical interface.

35. The nozzle of feature 12 wherein said tapered interface comprises a first region having a non-linear shaped frustoconical shape and a second region having a substantially linear frustoconical shape.

36. The nozzle of feature 35 wherein said first region of said tapered interface is disposed proximate a transition region between said tapered interface and an elongated portion of said tip insert and said tip retainer.

37. The nozzle of feature 28 wherein said nozzle housing comprises a portion having an inner diameter substantially sized to abut against an outer surface of said distal end portion of said tip retainer.
